(19) United States
(12) Patent Application Publication
(10) Pub. No.: US 2012/0030060 A1
(43) Pub. Date: Feb. 2, 2012

(54) DETERMINING A LIKELIHOOD OF SUITABILITY BASED ON HISTORICAL DATA

(75) Inventors: Zhidong Lu, Boxborough, MA (US); John Stauffer, Framingham, MA (US)

(73) Assignee: True Fit Corporation, Woburn, MA (US)

(21) Appl. No.: 13/192,576

(22) Filed: Jul. 28, 2011

Related U.S. Application Data
(60) Provisional application No. 61/368,334, filed on Jul. 28, 2010.

(51) Int. Cl. G06Q 30/00; G06F 15/18

(52) U.S. Cl. 705/26.7; 706/12

(57) ABSTRACT

Some embodiments of the invention determine whether a particular item is likely to suit a consumer from a fit and/or style standpoint, using objective data produced as a result of the consumer's experiences. For example, some embodiments of the invention analyze information regarding a consumer's experiences with certain products (e.g., purchase and return history, identification of “favorite” items, etc.) and data regarding attributes of those items (e.g., technical dimension data, stylistic and fit attributes, etc.) to determine the consumer's measurements and fit and/or style preferences, so that a prediction may be made regarding how a particular size of an item may suit the consumer.

### RELATED APPLICATIONS

This application claims priority to U.S. Provisional Patent Application Ser. No. 61/368,334, entitled “Determining A Likelihood Of Suitability Based On Historical Data,” filed Jul. 28, 2010, bearing Attorney Docket No. T0647.70001US00, which is incorporated herein by reference in its entirety.

### FIELD OF INVENTION

This invention relates to determining a likelihood that an item, such as an item of apparel or shoes, will suit a consumer based at least in part on the consumer's previous experiences with one or more other items.

### BACKGROUND

Conventional systems for predicting whether/how a particular size of an item (e.g., an item of apparel, shoes, etc.) will fit a particular consumer rely on information provided by the consumer, such as information on his/her measurements, body shape, style and/or fit preferences, etc. Relying on the consumer to provide this information (e.g., via a web interface) can result in a sub-optimal experience for the user, due to the drawn-out registration process typically required to collect the information needed to make a fit prediction. In addition, the information collected from the user may not be accurate. For example, the user may make errors in collecting the information (e.g., in measuring themselves) or in entering the information, and may also be unsure how to characterize him/herself in the manner specified (e.g., he/she may not know the difference between “straight” and “curvy” hips).

### SUMMARY OF INVENTION

Embodiments of the invention generate information about a consumer (e.g., his/her dimensions, body shape, fit and/or style preferences, etc.) by analyzing, among other information, data on the consumer's previous behavior. As a result, the consumer need not be required to expend time and effort on a process which commonly results in mistakes and mischaracterization. Rather, embodiments of the invention draw conclusions from actual experiences of the consumer.

In some embodiments of the invention, a consumer's body shape and/or fit/style preferences may be determined using objective data produced as a result of those experiences. For example, information regarding a consumer's experiences with particular products (e.g., purchase and return history, identification of “favorite” items, etc.) may be combined with data regarding attributes of those items (e.g., technical dimension data, such as waist circumference, outseam length, etc.; stylistic and fit attributes, such as intended fit profile, intended age range, etc.) to draw conclusions regarding the consumer's measurements, style and fit preferences, and other information. This information may then be provided as input to a process that determines the likelihood that a particular size of an item suits the consumer from a fit and/or style standpoint. This process may, for example, be employed by an online e-commerce system, installed on a computer system or kiosk (e.g., within a bricks-and-mortar store), accessible as a service via a mobile device, etc. Embodiments of the invention are not limited to any particular manner of implementation.

The foregoing is a non-limiting summary of the invention, some embodiments of which are defined by the attached claims.

### BRIEF DESCRIPTION OF DRAWINGS

FIG. 1 is a block diagram depicting example components of a system for implementing aspects of the invention, in accordance with some embodiments of the invention;

FIG. 2 is a flowchart depicting an example process for determining a likelihood that an item will suit a consumer, based at least in part on the consumer's previous experiences with other items, according to some embodiments of the invention;

FIG. 3 is a graph depicting weighted probabilities that corresponding items will suit a consumer in a given dimension, according to some embodiments of the invention;

FIG. 4 is a graph depicting a probability that an item exhibiting certain characteristics will suit a consumer, in accordance with some embodiments of the invention;

FIG. 5 is a block diagram depicting an example computer on which some embodiments of the invention may be implemented; and

FIG. 6 is a block diagram depicting an example memory on which instructions embodying aspects of the present invention may be stored.

### DETAILED DESCRIPTION

Embodiments of the invention may determine the likelihood that a particular size of an item suits a consumer from a fit and/or style standpoint, using objective data produced as a result of the consumer's experiences. As a result, the consumer need not endure a lengthy and error-prone registration process designed to gather information on the consumer's measurements and preferences.

Some embodiments of the invention analyze information regarding a consumer's experiences with particular products (e.g., purchase and return history, identification of “favorite” items, etc.) and data regarding attributes of those items (e.g., technical dimension data, stylistic and fit attributes, etc.) to determine the consumer's measurements and fit and/or style preferences, so that a prediction on how a particular size of an item may fit and otherwise suit the consumer may be made.

A non-limiting, simplified example of this analysis is described below with reference to Tables 1 and 2. This example is provided to illustrate certain aspects of some embodiments of the invention, but it should be appreciated that not all embodiments of the invention are limited to the types of analysis described below with reference to Tables 1 and 2, and that many embodiments may provide for drawing conclusions based at least in part on different and additional types of data, and/or using different and additional forms of analysis.

In this illustrative example, Table 1 includes information on a particular consumer's (i.e., User 1's) experiences with five separate products (i.e., Products 1, 2, 3, 4 and 5). These experiences are the result of User 1's purchase of each of the five products.

TABLE 1
Consumer Experience Data.

| User | Product | Experience |
|---|---|---|
| 1 | 1 | Purchased, not returned |
| 1 | 2 | Identified as ″favorite″ |
| 1 | 5 | Purchased, not returned |
| 1 | 3 | Returned, ″Too short″ |
| 1 | 4 | Returned, ″Didn't like style″ |

Table 2 includes information on each of six products, including the five listed above in Table 1. This information includes technical dimension data on each product (i.e., waist circumference and inseam length) as well as an indication of the target age range for each product (e.g., determined by the product's manufacturer). In Table 2, the technical dimension data is specified as a range, since some product manufacturers tolerate a range of dimensions in the manufacturing process.

TABLE 2
Product Data.

| | Waist | | Target Age |
|---|---|---|---|
| Product | Circumference | Inseam | Range |
| 1 | 29.5″-30.5″ | 33.5″-34.5″ | 25-35 |
| 2 | 29″-30″ | 34″-35″ | 25-45 |
| 3 | 29″-30″ | 33″-34″ | 25-35 |
| 4 | 29″-30″ | 34″-35″ | 35-45 |
| 5 | 29″-30″ | 34″-34.5″ | 25-35 |
| 6 | 29″-30″ | 34.5″-35″ | 25-45 |

Any of numerous conclusions may be drawn based at least in part on the data included in Tables 1 and 2. For example, because the information in Table 1 indicates that the consumer may have had a positive experience with products 1, 2 and 5 (i.e., the consumer identified product 2 as a favorite, and did not return products 1 and 5 after purchase), and the information in Table 2 identifies dimensions and a target age range for these products, conclusions may be drawn regarding the consumer's measurements and fit and/or style preferences, which may be employed in predicting how these and other items may suit the consumer from a fit and style standpoint. For example, a conclusion may be drawn that products having an inseam between 33.5″ and 35″ and a target age range between 25 and 35 are most likely to suit User 1.

Of course, the example described above is an oversimplified one provided merely for illustration. Some embodiments of the invention may consider numerous attributes of consumers and/or example products in identifying items that may suit a particular consumer well. In this respect, the approaches described herein may allow for identifying particular attributes that define products that suit a consumer particularly well, or do not suit the consumer well, so that predictions may be made on how certain items (e.g., with which the consumer has no prior experience) are likely to suit the consumer.

Some embodiments of the invention may ascribe greater importance to certain consumer experiences than others. For example, an indication that a consumer selected a first product as one of his/her favorites may be given greater consideration in making future predictions than an indication that a consumer purchased and did not return a second product, since an affirmative representation may indicate a greater affinity on the consumer's part for the first product than a non-return does for the second product, since a non-return could have happened for reasons other than an affinity for the second product. Embodiments of the invention may, for example, assign weights and/or employ other ways of giving certain types of experiences greater or lesser consideration in the analysis described herein. The invention is not limited to any particular manner of implementation.

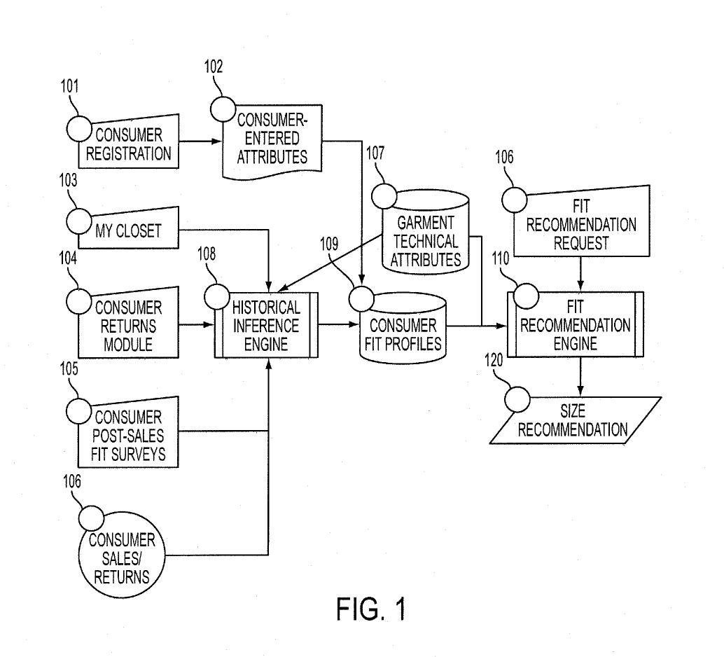

FIG. 1 depicts an example system for inferring a consumer's measurements and/or fit/style preferences based at least in part on the consumer's previous experiences with items of apparel. It should be appreciated that although the example system shown in FIG. 1 analyzes information relating to apparel, other systems embodying aspects of the invention may analyze information relating to any of numerous types of products and/or services. Embodiments of the invention are not limited in this regard.

The example system shown in FIG. 1 includes components which may each be generically considered to be one or more controllers for performing the functions described below. These controllers may be implemented in any of numerous ways, such as with dedicated hardware and/or by employing one or more processors programmed using software and/or microcode to perform the described functions. When implemented via software, the software code can be executed on any suitable processor or collection of processors, whether provided in a single computer or distributed among multiple computers. Where a controller accepts or provides data for system operation, the data may be stored in a central repository or a plurality of repositories.

The example system depicted in FIG. 1 includes consumer registration controller 101, consumer entered attributes data 102, my closet controller 103, consumer returns controller 104, consumer post-fit sales survey controller 105, consumer sales/returns data 106, garment technical attributes storage facility 107, historical inference controller 108, consumer fit profiles storage facility 109 and fit recommendation controller 110. Some example functions of, and communication between, these components are described below.

Consumer registration controller 101 provides a facility whereby a consumer may register and create a fit profile. For example, using consumer registration controller 101, a consumer may self-report fit-related attributes, such as body measurements, body shape attributes (e.g., stomach shape, seat shape, body shape, etc.), and/or other attributes. In the example system shown, consumer-Entered Attributes data 102 includes the attributes that a consumer enters during the registration process.

My closet controller 103 allows the consumer to specify one or more items of apparel that the consumer believes fit(s) him/her well. A specified item may, for example, be one which the consumer already owns, although embodiments of the invention are not limited in this respect. In some embodiments, my closet controller 102 may allow a consumer to specify sizes of individual items (e.g., Arrow Wrinkle-Free Fitted Herringbone Long Sleeve, Size 15 34/35), sizes of items within a brand category (e.g., Arrow Dress Shirt, Size 15 34/35), and/or any other group of items.

Consumer returns controller 104 collects information from a consumer as he/she initiates a return of an item. In some embodiments, consumer returns controller 104 may accept information regarding whether the item is being returned due to fit-related issues and if so the nature of the issue(s) (e.g., waist too tight, leg too short, thigh too loose, etc.). Any of numerous types of information regarding returns may be accepted.

Consumer post-sales fit survey controller 105 collects information from a consumer regarding how items which they have purchased have fit. In some embodiments, Consumer post-sales fit survey controller 105 generates and sends survey invitations (e.g., via email) to a sample group of consumers after they have completed purchases. In this respect, consumers on which a relatively smaller set of data has already been collected may be sent a survey to fill out. A survey may ask a consumer to rate specific items based on key dimensions. For example, a consumer who purchased pants may be asked to rate waist, hip thigh and/or length measurements, a consumer who purchased shoes may be asked to rate length, width and/or arch support of the shoe, etc. Ratings on any of numerous product dimensions may be requested and/or stored.

In some embodiments, any or all of consumer registration controller 101, my closet controller 103, consumer returns controller 104 and consumer post-sales fit survey controller 105 may be implemented via software code defining presentation of an interface (e.g., for execution by a web browser, e-mail client, and/or other component(s)) to a consumer, and accepting information provided by the consumer for storage.

Consumer sales/returns data 106 includes information regarding items that the consumer previously purchased and/or returned (e.g., to one or more retailers). Although depicted in FIG. 1 as a single data feed, consumer sales/returns data 106 may comprise any suitable number of datasets, each of which may be stored on any suitable medium and transferred using any suitable technique(s) and/or infrastructure.

Garment technical attributes storage facility 107 stores technical dimension data on certain sizes of items. Technical dimension data on items of apparel may be collected from any of numerous sources, such as from manufacturers of the items and/or one or more other sources.

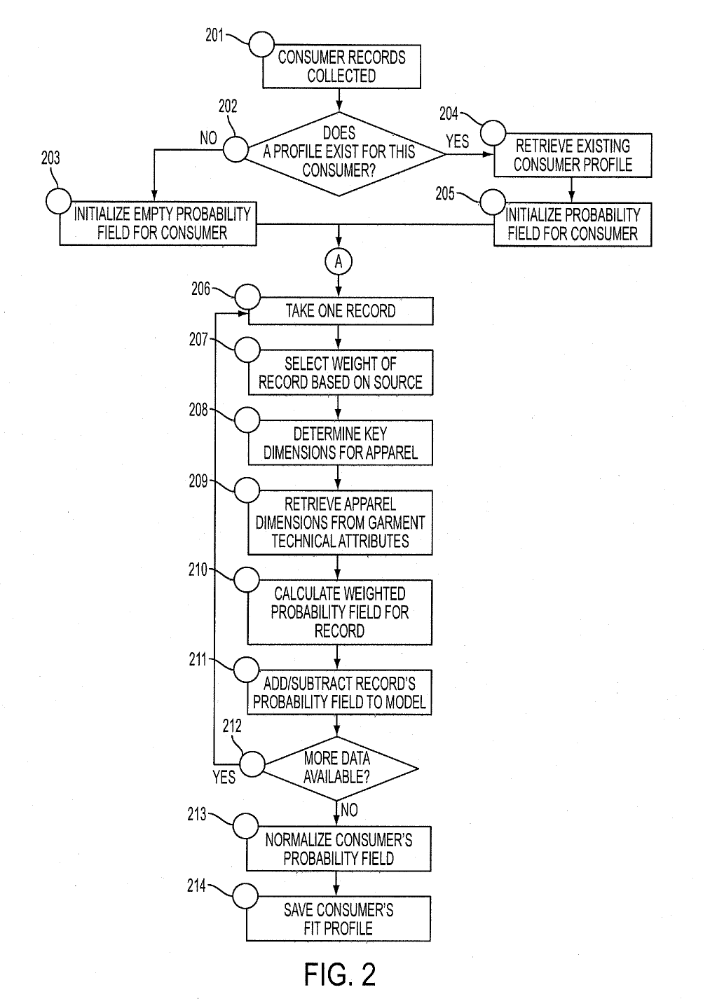

Historical inference controller 108 receives input from my closet controller 103, consumer returns controller 104 and consumer post-fit sales survey controller 105, and accepts as input consumer sales/returns data 106, and generates a model of the consumer's measurements, body shape and style/fit preferences. One example technique for producing this model is described below with reference to FIG. 2, and may include acts performed by historical inference controller 108 and/or one or more other components shown in FIG. 1.

Consumer fit profile storage facility 109 stores information collected about a consumer's preferences, identified measurements, closet, fit survey, product returns information, etc. by consumer registration controller 101, my closet controller 103, consumer returns controller 104 and consumer post-sales fit survey controller 105. Although depicted in FIG. 1 as a single repository, consumer fit profiles storage facility 109 may store data in any suitable number of repositories, as embodiments of the invention are not limited in this respect.

In the example system shown, fit recommendation controller 110 receives a fit recommendation request 100 and generates a size recommendation 120. A fit recommendation request may be submitted to request a size of a particular item that is predicted to fit the consumer. To make a prediction, fit recommendation controller 110 may draw on information stored in consumer fit profile storage facility 109 and garment technical attributes storage facility 107, such as to determine a size of the item that is most likely to fit the consumer. For example, in response to a request for a recommendation for a size of an item that is likely to best fit a consumer, fit recommendation controller 110 may query garment technical attributes storage facility 107 to determine the dimensions of available sizes of the item, query consumer fit profile storage facility 109 to determine the consumer's measurements and preferences (e.g., generated using the process described below with reference to FIG. 2), and use this information to identify a size of the item that is predicted to best fit the consumer.

It should be appreciated that some embodiments of the invention may also be capable of generating recommendations unrelated to fit (i.e., unrelated to whether an item has appropriate physical dimensions for a consumer). Any of numerous item attributes may be analyzed to determine a likelihood that an item suits a particular consumer, from any number of standpoints, including target age range, ease of fit, etc. Embodiments of the invention are not limited in this respect.

FIG. 2 depicts an example process 200 whereby historical inference controller 108 (FIG. 1) generates a consumer profile for a particular consumer from data relating to that consumer. It should be appreciated that the process 200 shown in FIG. 2 represents merely one example of an algorithmic approach that may be used to infer a consumer's measurements and/or style/fit preferences using objective data gleaned from the consumer's experiences with certain items. Any of numerous other algorithmic approaches may alternatively be employed, including a Bayesian network, and/or one or more other approaches. Embodiments of the invention are not limited to using any particular process or technique for analyzing information.

At the start of process 200, data about the particular consumer's experience with items of apparel is collected in act 201. This data may include, for example, information produced by one or more components shown in FIG. 1, including my closet controller 103, consumer returns controller 104, consumer post-fit survey controller 105, as well as information included in consumer sales/returns data 106.

Process 200 then proceeds to act 202, wherein a determination is made whether a fit profile already exists for the consumer or not. This determination may be made, for example, by querying consumer fit profile storage facility 109 (FIG. 1) to determine whether a fit profile for the consumer is stored. Based on the result of this determination, process 200 may proceed to retrieve the consumer's profile (if one previously existed) in act 204 and initialize that profile for updates in act 205, or to initialize a new profile for the consumer (if none previously existed) in act 203. In some embodiments, initializing a new profile for the consumer may involve generating an indication of an even probability that any apparel dimension will suit the consumer, indicating that not enough information has been collected to predict that any value for a dimension will fit the consumer.

At the conclusion of either of acts 203 or 205, process 200 proceeds to act 206, wherein a first record, reflecting the consumer's experiences with a first item, is retrieved from the data collected in act 201. In act 207, a weighting factor for the record is selected. As noted above, some embodiments of the invention may provide for ascribing greater importance to certain consumer experiences, such as those which resulted in an affirmative representation that an item suited or did not suit the consumer. For example, a record generated by the my closet controller 103 indicating that a certain item was designated as a favorite may be ascribed greater importance (e.g., by assigning it greater weight) than an experience reflected in consumer sales/returns data 106 indicating that the item was purchased and not returned, since the affirmative representation reflected in the data from my closet controller 103 may be deemed more indicative of the consumer's feelings toward an item than the data from consumer sales/returns data 106.

Process 200 then proceeds to act 208, wherein key dimensions known to be predictive of fit are identified. Any of numerous techniques may be used to identify key dimensions. In some embodiments, key dimensions may depend on the category of item for which a fit is to be predicted. For example, if the item is a shirt, then neck arm length and overall length dimensions may be identified as key dimensions. If the item is a pair of pants, then waist, rise and inseam dimensions may be identified as key dimensions. Any one or more dimensions may be designated as key dimensions for any category of item.

Process 200 then proceeds to act 209, wherein dimension data for the first item that corresponds to the key dimensions identified in act 208 are retrieved. In some embodiments, dimensions may be retrieved by querying garment technical attributes storage facility 107 (FIG. 1). For example, some embodiments may retrieve values for each key dimension for the first item. In some cases, values for some or all of the key dimensions may be expressed as a range of values, which may account for dimensional tolerances during manufacturing and “ease values” reflecting the intended fit of the item (e.g., tight, loose, etc).

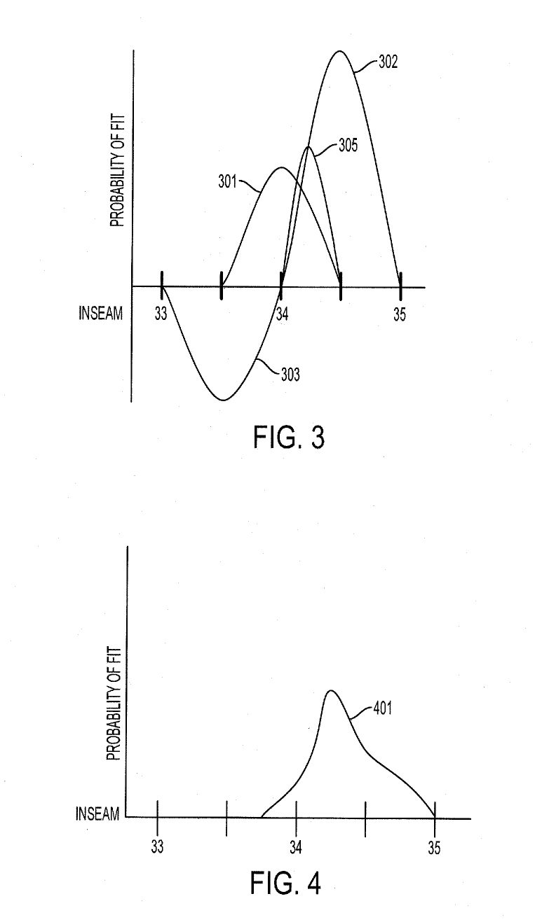

Process 200 then proceeds to act 210, wherein a weighted probability that the item will fit the consumer in a given dimension is calculated. One example technique for calculating a weighted probability is described below with reference to FIG. 3. Of course, other techniques may be employed, in addition to or instead of the approach described with reference to FIG. 3, as any of numerous implementations are possible. Further, it should be appreciated that a weighted probability may be calculated for any number of dimensions, as the invention is not limited in this respect. For example, act 210 may involve calculating a weighted probability for each key dimension identified in act 208.

In act 211, the weighted probability calculated in act 210 is added (e.g., if positive) or subtracted (e.g., if negative) to a most current statistical fit model for the dimension for the consumer in act 211. An example approach for updating a weighted probability for a dimension that an item will fit a consumer in a given dimension is described below with reference to FIG. 4. Of course, other techniques may be employed, in addition to or instead of the approach described with reference to FIG. 4, as embodiments of the invention are not limited in this respect. As noted above, a fit model may be updated for any suitable number of dimensions, such as each key dimension identified in act 208.

In act 212, a determination is made whether any dimension data for additional items was collected in act 201. If so, process 200 returns to act 206, and repeats until all dimension data is processed.

Process 200 then proceeds to act 213, wherein the consumer's fit model is normalized. In some embodiments, normalization may be accomplished by dividing the model for each dimension by the sum of the weights used to generate weighted probability values, although other techniques may alternatively be employed. As a result, act 213 results in an estimation of a range of dimensions, each with corresponding probability, of suiting the consumer. Items with known dimensions, or for which dimensions may be inferred, may be compared to these dimensions to estimate how those items may suit the consumer.

In act 214, the normalized model generated in act 213 is stored as part of the consumer's profile (e.g., in consumer fit profiles storage facility 109; FIG. 1). In some embodiments of the invention, the normalized model may be stored in a format which represents the shape of the resulting curve in each dimension. For example, normalized model may be stored as a series of numbers that provide an estimated shape of the curve for each dimension. Other embodiments may utilize parameterized curve shapes to store the normalized model as pre-defined mathematical functional form. Still other embodiments of the invention may employ other techniques. Any of numerous techniques may be employed.

Process 200 then completes.

As noted above, FIG. 3 illustrates an example approach for calculating a weighted probability for each of a plurality of items. In this respect, FIG. 3 depicts a Cartesian coordinate system having two axes, with the Y axis measuring the probability that an inseam dimension measured on the X axis will fit the consumer. The curve for each item represents inseam dimension data shown in Table 2, above. The curves for the different items are then combined to create the composite curve shown in FIG. 4, from which conclusions about other items for which dimension data is known can be drawn.

Each curve in FIG. 3 represents inseam data for one of products 1-5 in Table 2. It can be seen from Table 2 that Item 1 has an inseam dimension of 33.5″-34.5″ (expressed to account for manufacturing tolerance and design ease), and was purchased successfully once by the subject consumer. As a result, in the graph shown in FIG. 3, Item 1 is represented by curve 301 as a parabolic function which is centered on the 33.5″-34.5″ range (i.e., on 34″). It should be appreciated that although parabolic functions are used to represent weighted probabilities in FIG. 3, any of numerous other functional forms could alternatively be used (e.g., Gaussian probability distribution function, Gamma function, etc.).

It can be seen from the information in Table 2 that Item 2 has an inseam dimension of 34-35″, and so Item 2 is represented by curve 302, centered in the 34-35″ range (i.e., at 34.5″) in FIG. 3. The data in Table 2 indicates that Item 2 has been identified as a “favorite” by the consumer (e.g., via my closet controller 3, or one or more other components), and so Item 2 is given twice as much weight as (i.e., assigned a probability of properly fitting in the inseam dimension that is twice as great as) Item 1.

The information in Table 2 shows that Item 3 has an inseam dimension of 33″-34″ and was returned for being too short. As a result, in this example, curve 303 for Item 3 reflects a negative probability that the item fits properly in the inseam dimension.

It can be seen from the information shown in Table 2 that Item 4 was returned because the consumer did not like the style of the item. Because this data provides no indication how Item 4 fits in the inseam dimension, Item 4 is not shown in the example representation of FIG. 3. It should be appreciated, however, that the data on Item 4 may be used to calculate probabilities that the item will suit the consumer in other dimensions (e.g., in a “Target Age Range” dimension), and may thus appear on representations analogous to FIG. 3 showing data on those dimensions.

The information in Table 2 shows that Item 5 has an inseam dimension of 34″-34.5″ and was purchased without being returned. As a result, curve 305 for Item 5 is centered in this range (i.e., over 34.25″). In the example shown, the curve 305 for Item 5 is taller than the curve for Item 1, which was also purchased and not returned but is centered over a broader dimension range. This is so that the areas beneath the curves for Item 1 and Item 5 are identical, such that each is given equal weighting with respect to predicting fit in the inseam dimension.

FIG. 4 shows an example representation generated by combining the weighted probabilities reflected in FIG. 3. The curves of FIG. 3 may be combined in any of numerous ways, as embodiments of the invention are not limited in this respect. In the example shown, the curve 401 of FIG. 4 is generated by adding all of the curves shown in FIG. 3, and then dividing by a sum of curve weights. In the example shown, the curve 302 for Item 2 has a weight of 2.0 due to the item being designated a favorite, and the curves 301, 303 and 305 for Items 1, 3 and 5, respectively, each have a weight of 1.0. By combining the curves in this manner, the resulting curve 401 is normalized to the same scale as may be calculated for other dimensions for the consumer.

The curve 401 in FIG. 4 is a curve which represents a normalized probability (measured on the Y axis) that an inseam dimension (measured on the X axis) will fit the consumer. Using this information, conclusions can be drawn regarding other items having known dimensions. For example, it can be seen that another item that has an inseam dimension that is shorter than 33.75″ has zero probability of fitting the consumer properly. Conversely, an item having an inseam dimension of approximately 34.25″ has the greatest probability of fitting the consumer properly.

Curves (and/or other functional forms) like that which is shown in FIG. 4 may be generated for any number of dimensions, as the invention is not limited in this respect. Further, a dimension need not reflect a physical dimension of an item, and may reflect any one or more attributes for which a consumer may exhibit a preference, such as style attributes, etc. Embodiments of the invention are not limited in this respect.

Curves (and/or other functional forms) like curve 401 shown in FIG. 4 for each of multiple dimensions may be combined to reflect a predicted overall probability of fit. In some embodiments, in combining information, greater or lesser importance may be ascribed to certain dimensions in predicting overall fit. Further, the extent to which each dimension contributes to overall fit may vary by consumer, so that certain dimensions may be assigned more weight for consumers exhibiting certain attributes. As an example, for consumers determined be above a certain height, the inseam or outseam dimensions for pants may be ascribed greater importance than the waist circumference dimension, recognizing that these consumers may value pants having legs that are sufficiently long more than proper fit in the waist. Any of numerous variations (e.g., by consumer, group to which a consumer belongs, etc.) are possible.

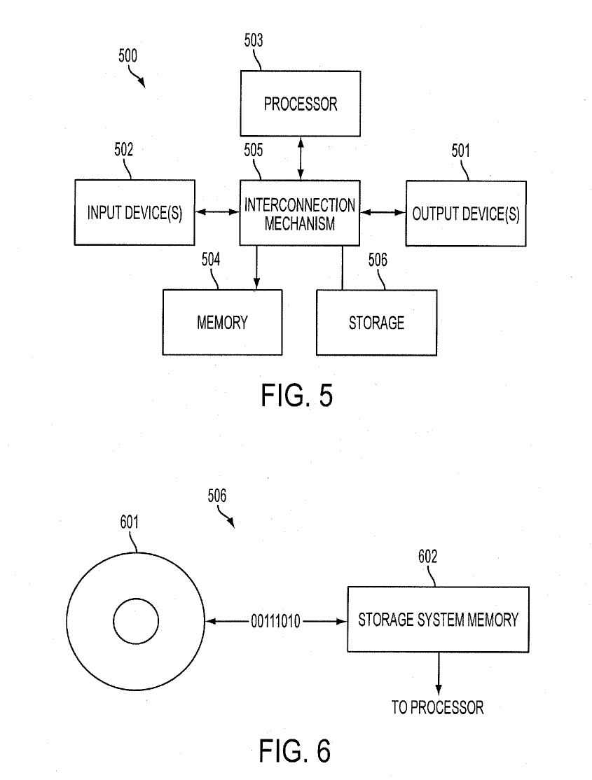

Various aspects of the systems and methods for practicing features of the invention may be implemented on one or more computer systems, such as the exemplary computer system 500 shown in FIG. 5. Computer system 500 includes input device(s) 502, output device(s) 501, processor 503, memory system 504 and storage 506, all of which are coupled, directly or indirectly, via interconnection mechanism 505, which may comprise one or more buses, switches, networks and/or any other suitable interconnection. The input device(s) 502 receive(s) input from a user or machine (e.g., a human operator), and the output device(s) 501 display(s) or transmit(s) information to a user or machine (e.g., a liquid crystal display). The input and output device(s) can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

The processor 503 typically executes a computer program called an operating system (e.g., a Microsoft Windows-family operating system, or any other suitable operating system) which controls the execution of other computer programs, and provides scheduling, input/output and other device control, accounting, compilation, storage assignment, data management, memory management, communication and dataflow control. Collectively, the processor and operating system define the computer platform for which application programs and other computer program languages are written.

Processor 503 may also execute one or more computer programs to implement various functions. These computer programs may be written in any type of computer program language, including a procedural programming language, object-oriented programming language, macro language, or combination thereof. These computer programs may be stored in storage system 506. Storage system 506 may hold information on a volatile or non-volatile medium, and may be fixed or removable. Storage system 506 is shown in greater detail in FIG. 6.

Storage system 506 may include a tangible computer-readable and -writable non-volatile recording medium 601, on which signals are stored that define a computer program or information to be used by the program. The recording medium may, for example, be disk memory, flash memory, and/or any other article(s) of manufacture usable to record and store information. Typically, in operation, the processor 503 causes data to be read from the nonvolatile recording medium 601 into a volatile memory 602 (e.g., a random access memory, or RAM) that allows for faster access to the information by the processor 503 than does the medium 601. The memory 602 may be located in the storage system 506 or in memory system 504, shown in FIG. 5. The processor 503 generally manipulates the data within the integrated circuit memory 504, 602 and then copies the data to the medium 601 after processing is completed. A variety of mechanisms are known for managing data movement between the medium 601 and the integrated circuit memory element 504, 602, and the invention is not limited to any mechanism, whether now known or later developed. The invention is also not limited to a particular memory system 504 or storage system 506.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

It should also be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound-generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer-readable medium (or multiple computer-readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or one or more other non-transitory, tangible computer-readable storage media) encoded with one or more programs that, when executed on one or more computers or other processors, perform methods that implement the various embodiments of the invention discussed above. The computer-readable medium or media may, for example, be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than that which is illustrated and described, which may include performing some acts simultaneously, even though shown as sequential acts in the illustrative embodiments described herein.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of determining a likelihood that a subject item will suit a subject consumer in a dimension, the method comprising:
(A) receiving data describing previous experiences by the subject consumer with each of a plurality of items, each of the plurality of items and the subject item being susceptible to characterization along a dimension, the dimension having a plurality of possible values;
(B) receiving data indicating a value for the dimension for each of the plurality of items;
(C) based at least in part on the data received in (A) describing previous experiences with each of the plurality of items and in (B) indicating a value for the dimension for each of the plurality of items, determining whether an item exhibiting a value for the dimension is likely to suit the consumer; and
(D) based at least in part on the value for the dimension for the subject item and the determination in (C), determining whether the subject item is likely to suit the subject consumer along the dimension.

2. The method of claim 1, wherein (C) comprises determining a probability that an item exhibiting a value for the dimension will suit the consumer, and wherein (D) comprises comparing the value for the dimension for the subject item to the probability determined for the value in (C) to determine a probability that the subject item will suit the subject consumer along the dimension.

3. The method of claim 1, wherein the dimension is a size, and (D) comprises determining whether the subject item's size along the dimension is likely to suit the subject consumer.

4. The method of claim 1, wherein the dimension comprises one or more of a target age range or ease of fit, and (D) comprises determining whether the subject item's target age range and/or ease of fit is likely to suit the subject consumer.

5. The method of claim 1, wherein the data received in (A) comprises data describing the subject consumer's previous purchases and/or returns of each of the plurality of items.

6. The method of claim 1, wherein the data received in (A) comprises an indication by the subject consumer that at least one of the plurality of items is a favorite of the consumer's.

7. The method of claim 1, wherein the determining in (C) comprises assigning greater importance to one or more experiences, described in the data received in (A), by the subject consumer with one of the plurality of items than other experiences by the subject consumer with one of the plurality of items.

8. The method of claim 1, wherein the subject item is an item of apparel or a pair of shoes.

9. The method of claim 1, wherein the determining in (C) comprises generating a model of the consumer's measurements, body shape, fit preferences and/or style preferences.

10. At least one computer readable storage medium having instructions encoded thereon which, when executed, perform a method comprising:
(A) receiving a request for a recommendation of a size of a particular item that will suit a consumer;
(B) analyzing data describing the consumer's previous experiences with each of a plurality of items and data describing at least one characteristic of each of the plurality of items to identify a size of the particular item that will suit the consumer; and
(C) provide a recommendation specifying the size of the particular item identified in (B).

11. The at least one computer readable storage medium of claim 10, wherein the data describing the consumer's previous experiences with each of the plurality of items comprises describing the consumer's previous purchases and/or returns of each of the plurality of items.

12. The at least one computer readable storage medium of claim 10, wherein the data describing the consumer's previous experiences with each of the plurality of items comprises an indication by the consumer that at least one of the plurality of items is a favorite of the consumer's.

13. The at least one computer readable storage medium of claim 10, wherein the analyzing in (B) comprises assigning greater importance to an experience by the consumer with one of the plurality of items than another experience by the consumer with one of the plurality of items.

14. The at least one computer readable storage medium of claim 10, wherein the analyzing in (B) comprises determining how various sizes of the particular item will suit the consumer along each of a plurality of dimensions.

15. The at least one computer readable storage medium of claim 10, wherein the particular item is an item of apparel or a pair of shoes.

16. A system, comprising:
at least one storage repository, storing:
first data describing previous experiences by each of a plurality of consumers with a plurality of items; and
second data characterizing each of the plurality of items along each of a plurality of dimensions, each dimension having a plurality of possible values, the second data comprising a value for each of the plurality of items along each of the plurality of dimensions;
at least one controller operable to access the first and second data stored by the at least one storage repository to determine whether an item is likely to suit one of the plurality of consumers along at least one of the plurality of dimensions.

17. The system of claim 16, wherein the at least one controller is operable to determine a probability that the item is likely to suit one of the plurality of consumers along at least one of the plurality of dimensions.

18. The system of claim 16, further comprising a facility operable to receive, from a first consumer of the plurality of consumers, an indication of the first consumer's physical attributes.

19. The system of claim 16, further comprising a facility operable to receive, from a first consumer of the plurality of consumers, an indication that one or more of the plurality of items suit the first consumer well along one or more of the plurality of dimensions.

20. The system of claim 16, further comprising a facility for soliciting information from one or more of the plurality of consumers regarding how one or more of the plurality of items suit the one or more consumers along one or more dimensions.
